(19) United States
(12) Patent Application Publication
(10) Pub. No.: US 2005/0118993 A1
(43) Pub. Date: Jun. 2, 2005

(54) Method for controlling radio resources assigned to a communication between a mobile terminal and a cellular infrastructure, and facilities

(76) Inventors: Pierre Roux, Argenteuil (FR); Thierry Lucidarme, Montigny-Le-Bretonneux (FR); Nidham Ben Rached, Paris (FR)

Correspondence Address: DLA PIPER RUDNICK GRAY CARY US LLP, P. O. BOX 64807, CHICAGO, IL, 60664-0807, US

(21) Appl. No.: 10/510,274

(22) PCT Filed: Feb. 18, 2003
(86) PCT No.: PCT/FR03/00526

(30) Foreign Application Priority Data
Apr. 5, 2002 (FR) 02/04251

(51) Int. Cl. H04Q 7/20

(52) U.S. Cl. 455/423; 455/425

(57) ABSTRACT

A cellular network infrastructure has radio network controllers and fixed transceivers serving respective cells. The proposed method of controlling radio resources assigned to a communication between a mobile terminal and such infrastructure comprises measuring parameters of respective propagation channels between the mobile terminal and a number of fixed transceivers. Report messages indicating at least some of the measured parameters are transmitted to the radio network controller to be processed. The measured parameters indicated in the report messages for at least one fixed transceiver include data representing a time variability of a power level received on the channel between the mobile terminal and this fixed transceiver.

The present invention relates to the digital mobile radio domain. It applies in particular to spread spectrum cellular networks using code division multiple access (CDMA) methods, for example in the third generation UMTS (Universal Mobile Telecommunication System) networks.

Spread spectrum techniques have the feature of allowing multiple propagation paths to be taken into account between the transmitter and the receiver, providing a significant increase in receive diversity.

A receiver conventionally used for this is the “rake” receiver, which comprises a certain number of “fingers” operating in parallel to estimate the digital symbols transmitted. The receive diversity gain results from the combination of the estimations obtained in the various fingers of the receiver.

In a spread spectrum CDMA system, the transmitted symbols, normally binary (±1) or quaternary (±1±j), are multiplied by spreading codes made up of samples, called “chips”, the rate of which is greater than that of the symbols, in a ratio called the spreading factor. Orthogonal or quasi-orthogonal spreading codes are allocated to various channels sharing the same carrier frequency, to enable each receiver to detect the symbol sequence that is intended for it, by multiplying the received signal by the corresponding spreading code.

The conventional rake receiver performs a coherent demodulation based on an approximation of the impulse response of the radio propagation channel by a series of peaks, each peak appearing with a delay corresponding to the propagation time along a particular path and having a complex amplitude corresponding to the loss and phase shift of the signal along that path (instantaneously producing fading). By analyzing a number of receive paths, that is, by taking multiple samples from the output of a filter tuned to the channel spreading code, with delays respectively corresponding to these paths, the rake receiver obtains multiple estimations of the symbols transmitted, which are combined to obtain a diversity gain. Combination can in particular be performed according to the MRC (Maximum Ratio Combining) scheme, which weights the various estimations according to the complex amplitudes observed for the various paths. To enable this coherent demodulation, pilot symbols can be transmitted with the information symbols for the estimation of the impulse response in the form of a succession of peaks.

Normally, in cellular systems, the fixed transceiver serving a given cell also transmits a beacon signal on a pilot channel which is allocated a predefined pilot spreading code. This pilot code is communicated to the mobile terminals located in or near the cell, by means of system information broadcast by the base stations. The terminals take measurements of the power received on the relevant pilot codes. These measurements are used by the mobile terminals on standby to identify the best cell to be used if they need to make a random access. They are also used to identify during a communication the cell or cells with which the radio link conditions are best in order to perform an inter-cell handover if necessary.

Another feature of spread spectrum CDMA systems is that they can support a macrodiversity mode. Macrodiversity consists in enabling a mobile terminal to communicate simultaneously with different fixed transceivers of a so-called active set. In the downlink direction, the mobile terminal receives the same information several times. In the uplink direction, the radio signal sent by the mobile terminal is captured by the fixed transceivers of the active set to form different estimations that are then combined in the network.

Macrodiversity provides a receive gain which improves the performance of the system by the combination of different observations of the same information.

It is also used to perform soft handovers (SHO), when the mobile terminal is roaming.

The macrodiversity mode leads, in the rake receiver of the mobile terminal, to the fingers allocated to a communication being assigned to paths belonging to different propagation channels, deriving from a number of fixed transceivers and normally having different spreading codes.

On the network side, the macrodiversity mode provides a sort of macroscopic rake receiver, the fingers of which are located in different transceivers. The estimations are combined after channel decoding in a base station if the latter contains all the transceivers concerned, or, otherwise, in a controller supervising the base stations.

Determining the optimal active set in a system having a macrodiversity mode is a difficult problem. Most of the algorithms for selecting cells for the active set operate on the basis of the radio losses measured on the pilot channels over periods measured in hundreds of milliseconds. The chosen active set corresponds to one or more cells for which the measured loss values are minimal.

Such a method is not optimal, because it does not take into account the structure of the propagation channel for each individual cell. However, for a given average loss value, it is advantageous to favor the inclusion in the active set of the cells least subject to fading, which are normally those for which there are the greatest number of propagation paths. Otherwise, the overall transmit power must be higher, which is unfavorable in terms of interference in the cellular network.

In a CDMA system like the UMTS, the transmit power on the radio interface is set by a locking procedure wherein the receiver returns to the transmitter transmit power control (TPC) commands for seeking to achieve a target in terms of reception conditions. These TPC commands consist of bits sent at a fairly high rate and the value of which indicates whether the transmit power must be increased or reduced.

In the case of a macrodiversity mode communication, the various fixed transceivers of the active set receive identical TPC bits from the mobile terminal. Respective corrective terms can be taken into account by these fixed transceivers in order to balance the transmit power levels. However, for a given active set, it may be preferable to aim for different power set points for the different transceivers. Otherwise, the macrodiversity gain imparted by the addition of new transceivers into the active set may be negative.

An object of the present invention is to optimize the use of the resources in a spread spectrum mobile network.

The invention thus proposes a method of controlling radio resources assigned to a communication between a mobile terminal and a cellular network infrastructure, the infrastructure comprising at least one radio network controller and fixed transceivers serving respective cells. This method comprises the steps of:
measuring parameters of respective propagation channels between the mobile terminal and a number of fixed transceivers;
transmitting to the radio network controller report messages indicating at least some of the measured parameters; and
processing the report messages on the radio network controller.

The measured parameters indicated in the report messages for at least one fixed transceiver include data representing a time variability of a power level received on the channel between the mobile terminal and said fixed transceiver.

The processing of the report messages on the radio network controller can include a macrodiversity control, that is, the determination of an active set of fixed transceivers with respect to the terminal and a radio link activation between the mobile terminal and each fixed transceiver of the active set.

Because of this, the active set management and handover control algorithm executed in the radio network controller is not limited to examining the overall receive power levels on the different propagation channels as in the normal systems. It also has information on the time variability of the power levels, enabling it to better assess the need to add or remove fixed transceivers in the active set.

Similar considerations can be applied to other radio resource control procedures, in particular to the active set transceiver transmit power management and power control algorithm executed in the radio network controller. In this case, the data on the time variability of the power levels is used by the radio network controller to better assess the need to increase or reduce the transmit power of the transceivers of the active set.

In some systems, such as the UMTS, the radio network controller determines the way in which the radio parameter measurements made by the terminals and/or by the fixed transceivers of the access network are returned to it. There is an event-triggered report mode, in which the occurrence of a specified event, detected by the terminal or the fixed transceiver, causes a report message to be sent to the controller, and there is a periodic report mode in which such a message is automatically sent at specified intervals.

Frequent returning of the measurements to the controller provides the controller with well updated information for deciding on various radio resource management actions. However, it results in a significant signaling load on the radio interface and in the access network, and it monopolizes the processing resources of the controller for measurement analyses which, if they are too frequent, only rarely lead to useful changes in the radio resource management.

An advantageous embodiment of the method according to the invention thus provides for the processing of the report messages indicating the data representing the time variability to the radio network controller to include the determination of the mode of transmission to the radio network controller of report messages indicating at least some of the measured parameters. The messages for which transmission is controlled in this way can be the same report messages as those that contain the variability data, or different messages used to report other measured parameters or the same parameters but measured in the other communication direction.

This determination of the transmission mode favors an event-triggered transmission mode when the data shows a time variability that is decreasing and/or less than a threshold for the power level received on the channel between the mobile terminal and a fixed transceiver with which the mobile terminal has an active radio link. Conversely, a periodic transmission mode, in particular with a short interval, can be favored when the data shows a time variability that is increasing and/or greater than a threshold.

The variability data of a power level typically comprises a variance (second order moment) of the time distribution of this power level, estimated during a measurement period. It can also include the estimation of one or more moments of order greater than 2 of that distribution.

The propagation channel parameter measurements, or at least some of them, can be downlink measurements performed by the mobile terminal on pilot signals respectively sent by the fixed transceivers and formed with predefined spreading codes. Some of these measurements can also be uplink measurements performed by the fixed transceivers on a pilot signal included in signals sent by the mobile terminal on a dedicated channel.

The invention also proposes radio network controllers, mobile terminals and base stations suited to the implementation of the above method.

A radio network controller according to the invention, for a cellular network infrastructure, comprises means of communication with fixed transceivers serving respective cells and with at least one mobile terminal, and means of controlling radio resources assigned to a communication between the mobile terminal and the cellular network infrastructure. The radio resource control means comprise means for requesting, through the communication means, parameter measurement report messages respective propagation channels between the mobile terminal and a number of fixed transceivers, and means of processing the report messages. The parameters indicated in the report messages for at least one fixed transceiver include data representing a time variability of a power level received on the channel between the mobile terminal and said fixed transceiver, taken into account by processing means.

A mobile radiocommunication terminal according to the invention comprises:
a radio interface for communicating with a cellular network infrastructure comprising at least one radio network controller and fixed transceivers serving respective cells;
means of measuring parameters of respective propagation channels from a number of fixed transceivers; and
means of transmitting to the radio network controller report messages indicating at least some of the measured parameters, including, for at least one fixed transceiver, data representing a time variability of a power level received on the channel from said fixed transceiver.

A base station according to the invention, for a cellular network infrastructure, comprises at least one radio transceiver serving a respective cell, and means of communication with at least one radio network controller of the cellular network infrastructure. Each radio transceiver includes means of measuring parameters of a propagation channel from a mobile terminal in communication with the cellular network infrastructure. The means of communication with the radio network controller include means of transmitting report messages indicating at least some of the measured parameters, including data representing a time variability of a power level received on said propagation channel from the mobile terminal.

Other particular features and advantages of the present invention will emerge from the description below of non-limiting exemplary embodiments, with reference to the appended drawings, in which:

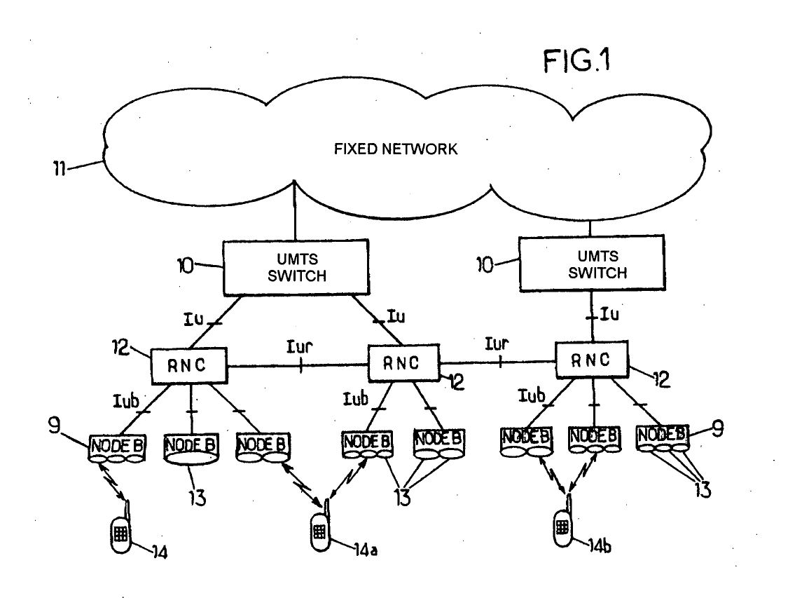

FIG. 1 is a diagram of a UMTS network;

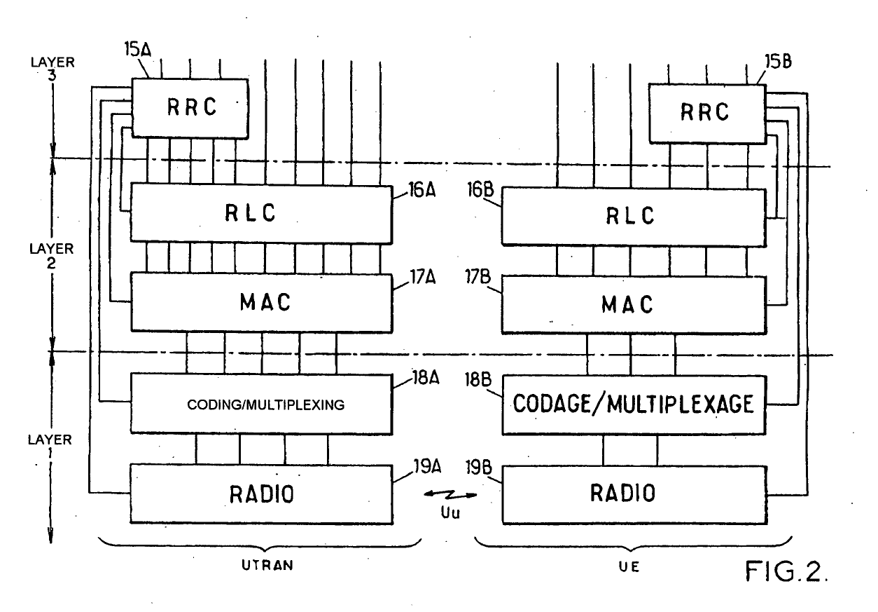

FIG. 2 is a diagram showing the layered organization of communication protocols employed on the radio interface of the UMTS network;

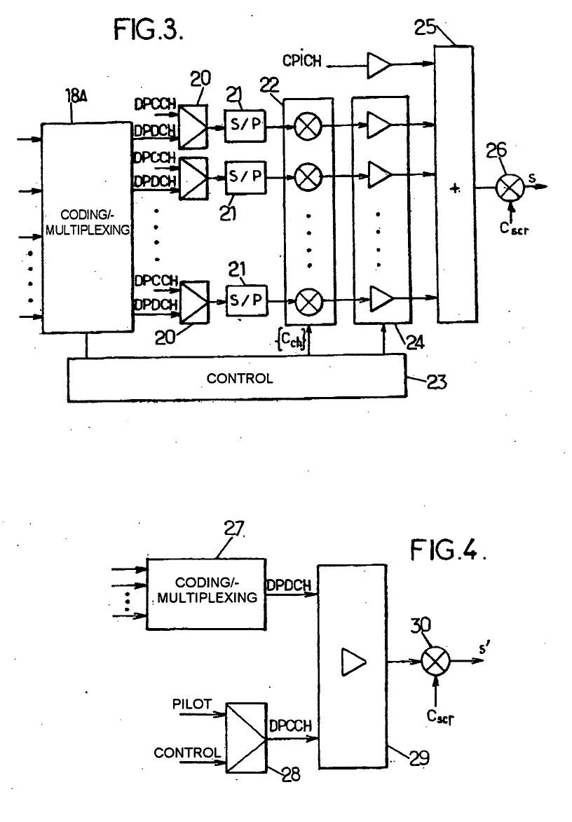

FIG. 3 is a block diagram of the transmit part of a radio transceiver of a UMTS base station;

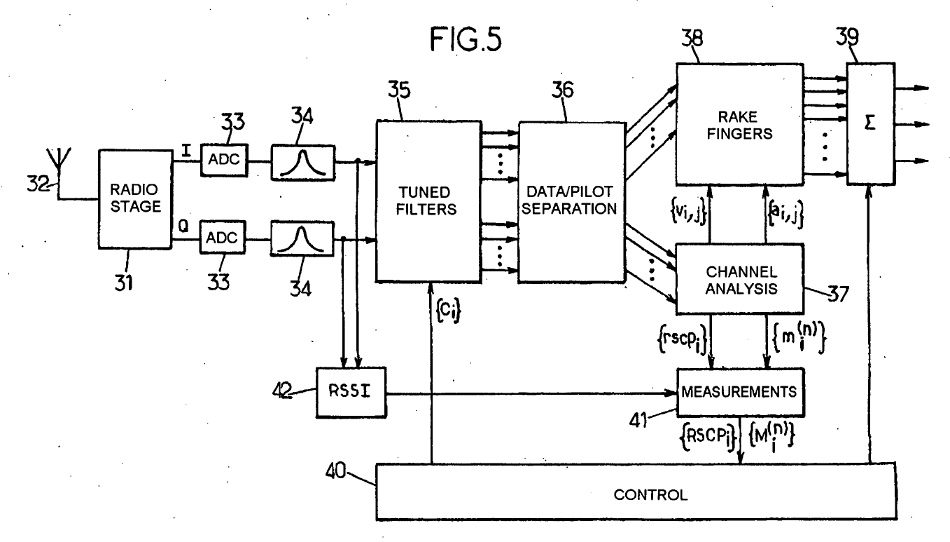

FIG. 4 is a block diagram of the transmit part of a UMTS mobile terminal;

FIG. 5 is a block diagram of a receiver of a UMTS station;

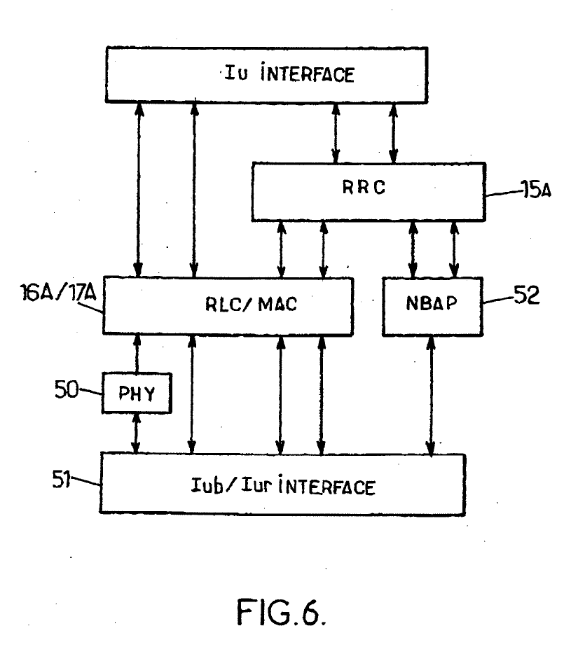

FIG. 6 is a block diagram of a UMTS radio network controller;

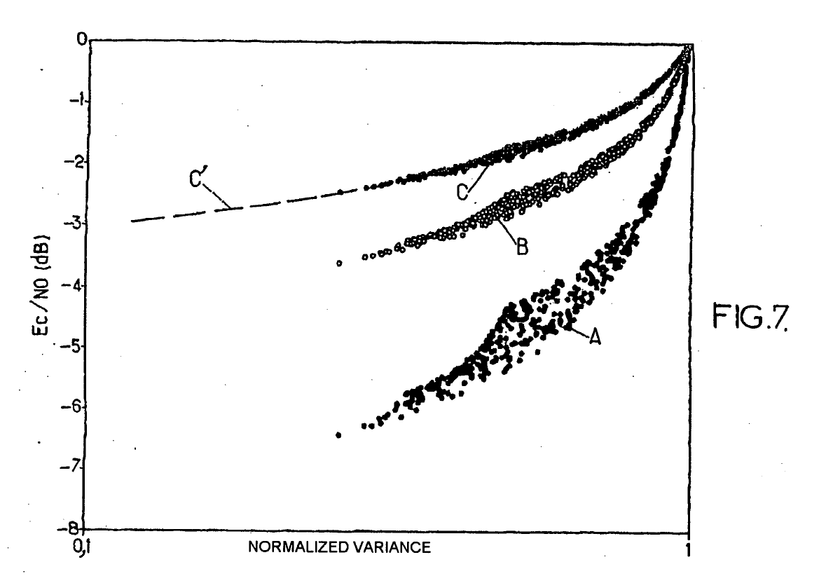

FIG. 7 is a graphic that can be used in certain embodiments of the invention; and

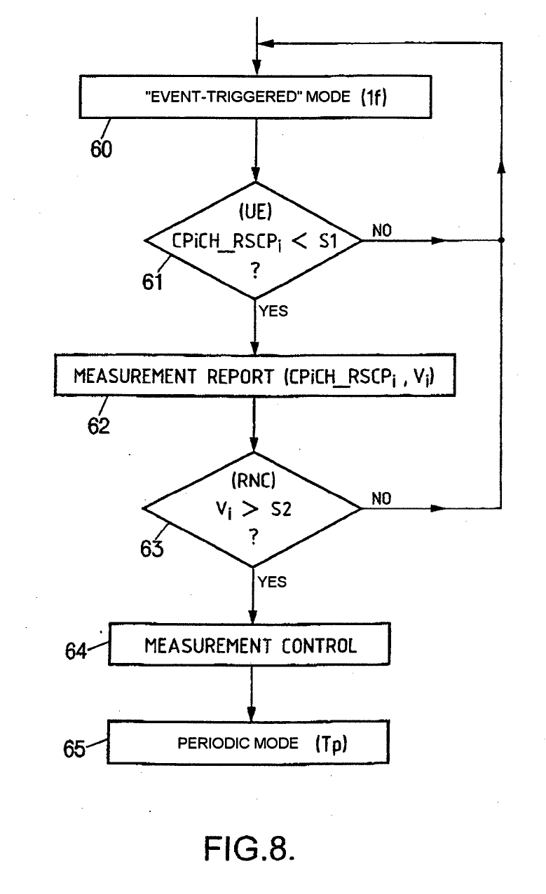

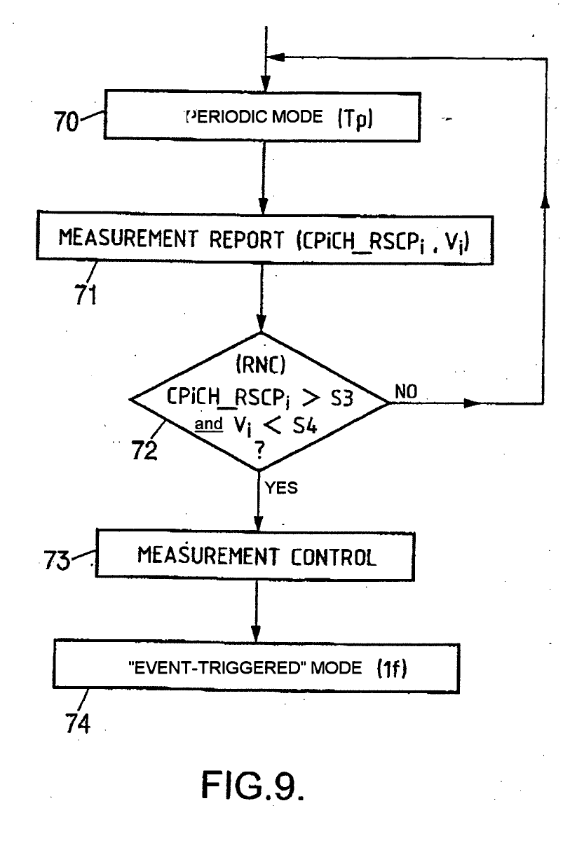

FIGS. 8 and 9 are flow diagrams of examples of radio resource control procedures executed in accordance with the invention.

The invention is described below in its application to a UMTS network, the architecture of which is shown in FIG. 1.

The mobile service switches 10, belonging to a core network (CN), are linked on the one hand to one or more fixed networks 11 and on the other hand, via an Iu interface, to radio network controllers (RNC) 12. Each RNC 12 is linked to one or more base stations 9 via an Iub interface. The base stations 9, distributed over the coverage area of the network, are capable of communicating by radio with the mobile terminals 14, 14a, 14b called user equipment (UE). The base stations 9, also called “nodes B”, can each serve one or more cells via respective transceivers 13. Some RNCs 12 can also intercommunicate via an Iur interface. The RNCs and the base stations form an access network called UTRAN (UMTS Terrestrial Radio Access Network).

The UTRAN comprises elements of layers 1 and 2 of the OSI model to provide the links required on the radio interface (called Uu), and a radio resource control (RRC) stage 15A belonging to layer 3, as is described in the technical specification 3G TS 25.301, “Radio Interface Protocol”, version 3.4.0 published in March 2000 by the 3GPP (3rd Generation Partnership Project). Seen from the higher layers, the UTRAN acts simply as a relay between the UE and the CN.

FIG. 2 shows the RRC stages 15A, 15B and the stages of the lower layers that belong to the UTRAN and to a UE. On each side, layer 2 is subdivided into a radio link control (RLC) stage 16A, 16B and a medium access control (MAC) stage 17A, 17B. Layer 1 comprises a coding and multiplexing stage 18A, 18B. A radio stage 19A, 19B handles the transmission of the radio signals from the symbol streams supplied by the stage 18A, 18B and the reception of the signals in the other direction.

There are various ways of adapting the protocol architecture according to FIG. 2 to the UTRAN hardware architecture according to FIG. 1, and normally different organizations can be adopted according to the channel types (see section 11.2 of the technical specification 3G TS 25.401, “UTRAN Overall Description”, version 3.1.0 published in January 2000 by the 3GPP). The RRC, RLC and MAC stages are located in the RNC 12. Layer 1 is for example located in the node B 9. A part of this layer may, however, be located in the RNC 12.

When a number of RNCs are involved in a communication with a UE, there is normally a serving RNC, called SRNC, hosting the modules that come under layer 2 (RLC and MAC), and at least one relay RNC, called “Drift RNC” (DRNC), to which is linked a base station 9 with which the UE is in radio contact. Appropriate protocols handle the interchanges between these RNCs on the Iur interface, for example ATM (Asynchronous Transfer Mode) and AAL2 (ATM Adaptation Layer No. 2). These same protocols can also be employed on the Iub interface for the interchanges between a node B and its RNC.

The layers 1 and 2 are each controlled by the RRC sublayer, the features of which are described in the technical specification TS 25.331, “RRC Protocol Specification”, version 4.1.0 published in June 2001 by the 3GPP. The RRC stage 15A, 15B supervises the radio interface. It also handles streams to be transmitted to the remote station according to a “control plane”, as opposed to the “user plane” which corresponds to the processing of the user data deriving from the layer 3.

The UMTS uses the spread spectrum CDMA technique, whereby the transmitted symbols are multiplied by spreading codes made up of samples, called “chips”, the rate of which (3.84 Mchips/s in the case of the UMTS) is greater than that of the symbols transmitted. The spreading codes distinguish different physical channels (PhCH) which are superposed on the same transmission resource made up of a carrier frequency. The auto- and intercorrelation properties of the spreading codes are used by the receiver to separate the PhCHs and extract the symbols that are intended for it.

For the UMTS in FDD (Frequency Division Duplex) mode on the downlink, a scrambling code is allocated to each transceiver 13 of each base station 9, and different physical channels used by this transceiver are distinguished by mutually orthogonal channelization codes. The transceiver 13 can also use a number of mutually orthogonal scrambling codes, one of them being a primary scrambling code. On the uplink, the transceiver 13 uses the scrambling code to separate the sending UEs and, where appropriate, the channelization code to separate the physical channels originating from any one particular UE. For each PhCH, the overall spreading code is the product of the channelization code and the scrambling code. The spreading factor (equal to the ratio between the rate of the chips and the rate of the symbols) is a power of 2 of between 4 and 512 inclusive. This factor is selected according to the symbol rate to be transmitted on the PhCH.

The various physical channels are organized into 10 ms frames which follow each other on the carrier frequency used. Each frame is subdivided into 15 time slots of 666 μs. Each time slot can convey the superposed contributions of one or more physical channels, made up of common channels and dedicated physical channels DPCH.

On the downlink, one of the common channels is a common pilot channel (CPICH). This channel carries a pilot signal, or beacon signal, formed from a predetermined sequence of symbols (see technical specification 3G TS 25.211, “Physical channels and mapping of transport channels onto physical channels (FDD)”, version 3.3.0 published in June 2000 by the 3GPP). This signal is transmitted by the transceiver 13 on the primary scrambling code of the cell, with a defined channelization code.

FIG. 3 diagrammatically illustrates the transmit part of a fixed transceiver 13 of a UMTS base station, serving a cell by means of a scrambling code cscr. Layer 1 can multiplex a number of transport channels (TrCH) originating from the MAC sublayer onto one or more PhCHs. The module 18A receives the data streams from the downlink TrCHs, originating from the RNC, and applies to them the coding and multiplexing operations required to form the data part (DPDCH) of the DPCHs to be sent. These coding and multiplexing functions are described in detail in the technical specification 3G TS 25.212, “Multiplexing and channel coding (FDD)”, version 3.3.0 published in June 2000 by the 3GPP.

This data part DPDCH is multiplexed in time, within each 666 ms time slot with a control part (DPCCH) comprising control information and predefined pilot symbols, as diagrammatically represented in FIG. 3 by the multiplexers 20 which form the binary streams of the DPCHs. On each channel, a serial/parallel converter 21 forms a complex digital signal, the real part of which is made up of the even-numbered bits of the stream and the imaginary part by the odd-numbered bits. The module 22 applies to these complex signals their respective channelization codes c_{ch}, which are allocated by a control unit 23. The module 24 weights the resulting signals according to the respective transmit power levels of the physical channels, determined by a power control process.

The complex signals of the different channels are then aggregated by the adder 25 before being multiplied by the scrambling code c_{scr} of the cell using the module 26. The adder 25 also receives the contribution of the CPICH, which is not multiplied by a channelization code since the channelization code of the CPICH is constant and equal to 1 (technical specification 3G TS 25.213, “Spreading and modulation (FDD)”, version 3.2.0 published in March 2000 by the 3GPP). The baseband complex signal s delivered by the module 26 is submitted to a formatting filter and converted to analog before modulating the carrier frequency by QPSK (Quadrature Phase Shift Keying), and before being amplified and transmitted by the base station.

The various transmission resources of the transceiver 13 are allocated to the channels by the unit 23 under the control of the RRC stage 15A located in the RNC. The corresponding control messages are transmitted via a control application protocol of the transceivers, called NBAP (“Node B Application Protocol”, see technical specification 3G TS 25.433, version 4.1.0, “UTRAN Iub Interface NBAP Signalling”, published in June 2001 by the 3GPP).

FIG. 4 diagrammatically illustrates the transmit part of a UE. It is assumed here that this UE transmits on a single physical channel. The module 27 handles the coding and, where appropriate, the multiplexing of the TRCHs corresponding to a physical channel. This forms a real signal (DPDCH) which is transmitted on a channel I. At the same time, control information and pilot signals are assembled by a module 28 to form a real signal (DPCCH) which is transmitted over a channel Q. The digital signals of the channels I and Q form the real and imaginary parts of a complex signal, the transmit power of which is adjusted by a module 29. The resulting signal is modulated by the spreading code of the channel made up of a scrambling code cscr, as represented by the multiplier 30. The resulting baseband complex signal s' is then filtered, converted to analog before modulating the carrier frequency by QPSK.

FIG. 5 is a block diagram of a CDMA receiver which may be located in the UE for the downlink, or in the node B for the uplink. This receiver comprises a radio stage 31 which performs the analog processes required on the radio signal captured by an antenna 32. The radio stage 31 delivers a complex analog signal, the real and imaginary parts of which are digitized by the analog-digital converters 33 on respective processing channels I and Q. On each channel, a filter 34 adapted to the formatting of pulses by the transmitter produces a digital signal at the rate of the chips of the spreading codes.

These digital signals are submitted to a battery of tuned filters 35. These filters 35 are tuned to the spreading codes cᵢ of the channels to be taken into account. These spreading codes cᵢ (products of a scrambling code and a channelization code, where appropriate) are supplied to the tuned filters 35 by a control module 40 which manages in particular the allocation of the resources of the receiver. At the node B end, the control module 40 is supervised by the RRC stage 15A of the RNC via the NBAP protocol. On the UE side, the control module 40 is supervised by the RRC stage 15B.

For N physical channels (spreading codes) taken into account, the tuned filters 35 deliver N real signals on the channel I and N real signals on the channel Q, which are supplied to a module 36 for separating the data from the pilot signals. For the downlinks, the separation consists in extracting the portions of the time slots containing the complex pilot signals sent by the node B to supply them to the channel analysis module 37, the corresponding data being addressed to the fingers 38 of the rake receiver. In the case of the uplinks, the separation performed by the module 36 consists in extracting the real pilot signals of the channel Q relating to each channel, to supply them to the analysis module 37.

For each physical channel, denoted by an integer i, the analysis module 37 identifies a certain number of propagation paths, denoted by j, based on the portion of the output signal of the tuned filter 35 corresponding to the pilot symbols, which constitutes a sampling of the impulse response of the channel.

There are various possible ways of representing the propagation paths for the rake receiver. One method consists in searching for the maxima of the impulse response of the channel sampled at the output of the tuned filter 35, averaged over a period of around 100 milliseconds. Each propagation path is then represented by a delay t_{i,j} corresponding to one of the maxima, of instantaneous amplitude a_{i,j}. In this case, the processing performed in each finger 38 of the rake receiver, allocated to the path j of the channel i, consists in sampling the signal received on the channel i with the delay t_{i,j} and multiplying the result by a_{i,j}*. The selected paths are those for which the receive powers are the greatest, the receive power according to a path j of a channel i being equal to the average of |a_{i,j}|².

In another possible representation (see WO01/41382), each propagation path of a channel i is represented by a specific vector v_{i,j} of the autocorrelation matrix of the impulse response vector supplied by the tuned filter 35. In the processing performed in the finger 38 of the rake receiver, the sampling with the delay t_{i,j} is then replaced by the scalar product of the output vector of the tuned filter 35 by the specific vector v_{i,j}. To estimate the specific vectors v_{i,j}, the analysis module 37 performs a diagonalization of the autocorrelation matrix, which also supplies the associated specific values λ_{i,j}. The specific value λ_{i,j}, equal to the expected value of |a_{i,j}|², represents the receive power of the signal on the path j of the channel i.

The combination module 39 of the rake receiver receives the contributions from the fingers 38 and, for each channel i, computes the sum of the respective contributions of the chosen paths j, indicated by the control module 40. The result is the local estimation of the information symbols transmitted on the channel i.

In the case of a UE receiving downlink signals in macrodiversity mode, that is, from a number of transceivers 13 using different spreading codes, the module 39 can also add the contributions of the corresponding propagation channels to obtain the diversity gain. The resulting combined estimations are then submitted to the decoding and demultiplexing stage (not represented in FIG. 5).

In the case of a base station 9 receiving on a number of transceivers 13 uplink signals from the same mobile terminal in macrodiversity mode, the local estimations delivered by the respective combination modules 39 of these transceivers 13 are also combined to obtain the diversity gain.

In the case of an uplink macrodiversity between a number of base stations 9 receiving signals from the same mobile terminal, the local estimations delivered by the respective combination modules 39 of the transceivers 13 are submitted to the decoding and demultiplexing stage (not represented in FIG. 5) to obtain the estimated symbols of the TrCH or TrCHs concerned. These symbols are transmitted to the SRNC via the Iub (Iur) interface in which they are combined to obtain the diversity gain.

The combination module corresponding to the RNC 12 is designated by the reference 50 in FIG. 6. This module recovers on the Iub and/or Iur interface 51 the symbols of the TrCH obtained from the various base stations and supplies them to the MAC stage 17A after combination. In the downlink direction, this module 50 belonging to the physical layer is responsible for broadcasting the streams of the TrCHs originating from the MAC stage 17A to the base stations concerned.

FIG. 6 also diagrammatically illustrates an instance 52 of the NBAP protocol executed on the RNC 12 to control a remote base station. The dialog between the RRC stage 15A of the RNC and that 15B of a UE is performed via an “RRC connection” managed as described in section 8.1 of the abovementioned technical specification 3G TS 25.331.

The procedures of the RRC protocol include measurement procedures described in section 8.4 of the technical specification 3G TS 25.331, which are used mainly to update the active set for the UEs in macrodiversity mode (or SHO) and to adjust the transmit power levels of the transceivers of the active set. The measurements required by the RNC are requested of the UEs in “MEASUREMENT CONTROL” messages, wherein the report modes are also indicated, for example with a specified interval or in response to certain events. The measurements specified by the RNC are then performed by the UE which returns them on the RRC connection in “MEASUREMENT REPORT” messages (see sections 10.2.17 and 10.2.19 of the technical specification 3G TS 25.331). These “MEASUREMENT CONTROL” and “MEASUREMENT REPORT” messages are relayed transparently by the transceivers 13 of the base stations.

A number of non-standardized algorithms can be used by the SRNC to determine the transceivers 13 of the active set. Examples of these will be examined later.

In some cases, these algorithms for determining the active set can take into account uplink measurements, performed by the transceivers 13 of the base stations and returned in accordance with the NBAP procedures described in sections 8.3.8 to 8.3.11 of the abovementioned technical specification 3G TS 25.433. The RNC indicates to the node B the measurements that it needs in a “DEDICATED MEASUREMENT INITIATION REQUEST” message, and the node B returns them in a “DEDICATED MEASUREMENT REPORT” report message (see sections 9.1.52 and 9.1.55 of the technical specification 3G TS 25.433).

Changes to the active set are notified to the UE (control module 40 of the receiver) via the active set update in SHO procedures of the RRC protocol, described in section 8.3.4 of the technical specification 3G TS 25.331 (“ACTIVE SET UPDATE” message of section 10.2.1).

These changes also give rise to the transmission of signaling from the RNC to the base stations 9 via the radio link setup, addition, reconfigure and delete procedures of the NBAP protocol, described in section 8 of the technical specification 3G TS 25.433.

The measurements taken into consideration by the RNC to control the radio links in SHO include power measurements performed on the signals or pilot channels, obtained by a measurement module 41 represented in FIG. 9. Various measurements that the mobile terminals and the base stations need to be able to carry out are listed in the technical specification 3G TS 25.215, “Physical layer—Measurements (FDD)”, version 3.3.0 published in June 2000 by the 3GPP. The measurements obtained by module 41 are transmitted to the RNC via the control module 40 and the RRC connection (UE measurement) or the NBAP protocol (node B measurement).

For a given channel i, the sum of the specific values λ_{i,j}, determined by the analysis module 37 for the p propagation paths taken into consideration (1≦j≦p), represents the overall power received on the channel, reduced to the duration of a symbol. This power is called RSCP (Received Signal Code Power) in the standard. The analysis module 37 also determines for each channel i the residual power of the noise after taking into account the p paths. This residual power is called ISCP (Interference Signal Code Power) in the standard. The quantity (RSCP/ISCP)×(SF/2) represents the signal-to-interferer ratio (SIR) for a downlink channel, SF designating the spreading factor of the channel. The SIR is equal to (RSCP/ISCP)×SF for an uplink channel.

In practice, an RSCP type quantity is estimated in the physical layer of the receiver (module 37) over a duration d₁ of around a hundred milliseconds, and the estimated value is returned to the RRC layer (or NBAP) if a corresponding parameter is required by the RNC. Normally, it is required with a greater averaging period d₂₁ for example of around half a second. The values returned by the physical layer are thus averaged between themselves by the module 41 to determine the measurement to be supplied to the RNC. The two estimation periods d₁, d₂ are adjustable.

The SIR, evaluated on the pilot symbols transmitted on a dedicated channel, is a measurement that the RNC can ask of the UE or the node B, and it may, where appropriate, take account of it in managing the active set.

The radio receiver is also capable of measuring the received power in the bandwidth of the signals around a UMTS carrier. This power, measured by a module 42 upstream from the tuned filters 35, is indicated by the quantity called RSSI (Received Signal Strength Indicator).

The UEs in communication monitor in parallel the received power levels on the CPICH channels of the cells belonging to a monitored set MS comprising the active set and a certain number of neighboring cells. These power levels are normally returned to the RNC in the “MEASUREMENT REPORT” messages. The quantities returned can be the absolute power levels (CPICH_RSCP) or power levels normalized with respect to the received signal power (CPICH_Ec/NO=CPICH_RSCP/RSSI). Given that the network signals to the UEs the transmit power levels of the nodes B on the CPICH channels, denoted CPICH_Tx_Power, the UE can also compute the pathloss of the signal on the propagation channel from each node B of the monitored set (PL=CPICH_Tx_Power/CPICH_RSCP). The standard allows for the RNC to be able to ask the UE to report this pathloss parameter to it (3G TS 25.331, sections 10.3.7.38 and 14.1.1).

To allow for a more detailed inclusion of the propagation characteristics by the algorithms for determining the active set and controlling power for this active set, it is advantageous also to transmit to the RNC data dependent on the time variability of the received power level. For this, selections of particular values are provided in the “INTRA-FREQUENCY MEASUREMENT” and “MEASURED RESULTS” information elements (IE) of the abovementioned “MEASUREMENT CONTROL” and “MEASUREMENT REPORT” messages of the RRC protocol for the downlink measurements, and in the “DEDICATED MEASUREMENT TYPE” and “DEDICATED MEASUREMENT VALUE” IEs of the abovementioned “DEDICATED MEASUREMENT INITIATION REQUEST” and “DEDICATED MEASUREMENT REPORT” messages of the NBAP protocol for the uplink measurements.

The analysis module 37 of the receiver computes the specific values λ_{i,j}=E(|a_{i,j}|²), which are aggregated on the path j to obtain the RSCP of the channel i estimated over the duration d₁:

$${rscp}_{i} = {\sum }_{j} {λ}_{i , j} .$$

It also has instantaneous values of the complex amplitudes a_{i,j} corresponding to the successive pilot symbols, and therefore instantaneous power levels

$${r}_{i} = {\sum }_{j} {\vert {a}_{ij} \vert}^{2}$$

for which rscpᵢ is the expected value estimated over the duration d₁. According to the invention, the module 37 also estimates one or more nth-order moments of the time distribution of the power levels rᵢ, given by mᵢ⁽ⁿ⁾=E(rᵢⁿ−E(rᵢ)ⁿ). In a simple embodiment, this estimation is limited to the n=2^{nd}-order moment, that is, to the variance: mᵢ⁽²⁾=E(rᵢ²)−rscpᵢ².

The measurement module 41 recovers the values rscpᵢ and Mᵢ⁽ⁿ⁾ and calculates from them the respective averages over the duration d₂ specified by the RNC in the “MEASUREMENT CONTROL” message to obtain the measurements RSCPᵢ (average of rscpᵢ) and Mᵢ⁽ⁿ⁾ (average of mᵢ⁽ⁿ⁾) to be transmitted to the RNC 12.

In a typical embodiment, the physical channels concerned will be the CPICHs originating from the transceivers of the monitored set MS, the measurements being returned by the UE in the form of pairs (RSCPᵢ, Vᵢ) or (PLᵢ, Vᵢ) with Vᵢ=Mᵢ⁽²⁾ and PLᵢ designating the pathloss computed for the cell i. It is also possible to return one or more moments of order n>2.

The physical channels concerned can also be dedicated channels, the measurements being performed either from the UE end or from the node B end. In this case, the measurements duly provided to the RNC are limited to the cells of the active set.

FIG. 7 shows results of simulations of the relationship between the standardized variance

$$\frac{{V}_{i}}{{( {RSCP}_{i} )}^{2}}$$

and the ratio Ec/N0 (power per chip over noise power density, expressed in dB) needed to obtain a given binary error rate (BER) at the output of a rake receiver applying the MRC method to process the paths of the propagation channel i. Each point corresponds to a simulated propagation profile, taken at random by varying the number of paths and their relative power levels. The clouds of points A, B and C respectively correspond to BERs of 1%, 5% and 10%.

This graphic shows that, given equal pathlosses, there is benefit in favoring the propagation channels for which the estimated variance is low because they require a lower Ec/N0 ratio. These channels are normally those which present the most decorrelated paths.

This effect can be exploited in various control procedures of radio resources supervised by the RNC, in particular for determining the active set and adjusting the transmit power level of the transceivers of the active set with respect to a mobile terminal.

To determine the active set, the algorithm executed on the RNC can allow as input variables the pathlosses PLᵢ and the variances Vᵢ measured by the UE for the various cells of the monitored set MS and returned on the RRC connection. The pathlosses PLᵢ may have been explicitly requested of the UE, or be deduced by the RNC from RSCPᵢ type measurements, given that the power levels CPICH_Tx_Power are known to the RNC, for broadcasting with the system information.

By way of example, the algorithm for determining the active set can consider various subsets C(k) of cells of the monitored set MS, which are candidates to make up the active set relative to a given UE (k=1, 2, . . . ) and choose the one that maximizes a criterion R(k) defined as follows. PLₘᵢₙ denotes the lowest pathloss value (corresponding to the best gain) among the cells of the monitored set

$$( {PL}_{min} = {min}_{i ∈ MS} \{ {PL}_{i} \} ) ,$$

and D(k)=

$$10 \times {log}_{10} ( \frac{{PL}_{min}}{N ( k ) \cdot {\sum }_{i ∈ C ( k )} {PL}_{i}} ) ,$$

the budget (negative or zero) of the candidate set C(k) consisting of N(k) cells relative to the candidate set made up of the single cell presenting the lowest pathloss value, assuming that the transmitted power would be distributed uniformly between the N(k) cells. After having estimated the quantities D(k), some of the candidate sets C(k), for which these quantities fall below a predefined negative threshold, for example around −2 to −5 dB, may, if necessary, be eliminated. For each remaining candidate C(k), a diversity gain G(k) is then estimated from the normalized variance N(k) of the sum of the contributions of the V(k) cells. In the case of a set C(k) of N(k)=2 cells of index i and j, this normalized variance is given by

$$V ( k ) = \frac{{PL}_{i}^{2} \cdot {V}_{i} + {PL}_{j}^{2} \cdot {V}_{j}}{{( {PL}_{i} + {PL}_{j} )}^{2}} ,$$

still assuming a uniform distribution of the transmitted power level between the cells. Using a chart or an empirical formula, this normalized variance V(k) is converted into a gain G(k) in terms of ratio Ec/N0 (G(k)≧0, expressed in dB), referring to a predefined BER value. It is common practice to refer to a BER of 10%, so that such an empirical formula can be obtained using a parametric curve C′ presenting a minimum distance, for example in the least squares sense, with the points C corresponding to this BER reference in a channel simulation such as that illustrated by FIG. 7. The criterion R(k) to be maximized is finally evaluated by calculating the sum of the quantity D(k) and of the diversity gain G(k), or R(k)=D(k)+G(k).

The objective of the procedures for adjusting the transmit power level of the transceivers of the active set with respect to a mobile terminal is to balance the downlink power transmitted by these fixed transceivers (section 5.2 of the technical specification TS 25.214, “Physical Layer procedures (FDD)”, version 3.6.0, published by the 3GPP in March 2001). The way in which the RNC controls the nodes B to supply them with the balancing parameters required is described in section 8.3.7 of the abovementioned technical specification 3G TS 25.433. The “Pref” parameter, described in said section, can be adjusted cell by cell to control the distribution of the power over all of the transceivers of the active set. There again, numerous power control strategies can emerge.

By way of example, in a case where the active set (determined as indicated previously or by any other method) comprises two cells of index i and j, for which the pathloss values PLᵢ are not too far apart, in the sense that their deviation is less than a predefined threshold, one possibility is to apply to the cell i a weighting coefficient xᵢ given by

$$xi = \frac{{PL}_{j} \cdot {V}_{j}}{{PL}_{i} \cdot {V}_{i} + {PL}_{j} \cdot {V}_{j}}$$

and to the cell j a weighting coefficient xⱼ=1−xᵢ, to favor the cell for which the variance is the lower, that is, the one that generates the most diversity.

The power variances to be applied can normally be determined empirically using simulations. The result is then a mapping table giving the transmit power level adjustment parameters to be addressed to each of the transceivers, according to different pathloss and variance values for each transceiver. Once compiled, this table can be stored in the RNC 12. The latter can refer to it after analyzing the measurements that are returned to it, so as to return to each transceiver the adjustment parameters appropriate to their transmit power level.

When the variability data measurements are performed on dedicated channels (by the nodes B or by the UEs) rather than on the CPICHs, the way they are taken into account by the transmit power adjustment procedures can be similar to that which has just been described. When determining the active set, these measurements are mainly for use in deciding whether a given cell must be kept in the active set.

Another example of the use of the variability measurements supplied to the RNC in accordance with the invention is the fixing of the initial set point for the closed loop for controlling the transmit power level from a UE. In a known method (see technical specification 3GPP TS 25.401, version 4.2.0 published in September 2001, section 7.2.4.8), the transmit power of the UE is compelled upward or downward by TPC (Transmit Power Control) bits inserted by the node B in each 666 μs time slot. These TPC bits are determined by the node B in a fast closed loop designed to align the SIR of the signal received from the UE on a set point SIR_{target} that the RNC assigns to it. This set point is determined by the RNC in a slower outer loop so as to achieve a communication quality objective, normally expressed in terms of block error ratio (BLER). It is desirable to fix an appropriate initial value for the set point SIR_{target} to reduce the convergence time of the outer loop. This can be performed by taking into account the variability data measured by the mobile on the CPICH before setting up the channel and returned to the RNC: the initial SIR_{target} will typically be chosen lower when the measured variance is low than when it is high. This initial value is supplied to the node B in the RADIO LINK SETUP REQUEST message of the NBAP protocol (3G TS 25.433, sections 8.2.17 and 9.1.36).

The variability measurements supplied to the RNC in accordance with the invention can also be used in the context of procedures for determining the mode of transmission to the RNC of “MEASUREMENT REPORT” messages from a UE, or “DEDICATED MEASUREMENT REPORT” messages from a node B.

The standard provides for an event-triggered report mode and a periodic report mode. In the periodic mode, a number of report intervals can be defined. In the event-triggered mode, a number of triggering events can be defined.

In the RRC protocol, the periodic or event-triggered mode is specified by the “MEASUREMENT REPORTING MODE” IE of the “MEASUREMENT CONTROL” message, whereas the frequency or the triggering event is specified in the “INTRA-FREQUENCY MEASUREMENT” IE of this same message (3G TS 25.331, sections 10.2.17, 10.3.7.36 and 10.3.7.49). The possible intervals range from 250 ms to 64 s (section 10.3.7.53). Nine families of triggering events, denoted 1a to 1i, are provided (section 10.3.7.39).

In the NBAP protocol, the periodic or event-triggered mode is specified by the “REPORT CHARACTERISTICS” IE of the “DEDICATED MEASUREMENT INITIATION REQUEST” message as is the interval or the triggering event (3G TS 25.433, sections 9.1.52 and 9.2.1.51). Possible intervals range from 10 ms to one hour. Six families of triggering events, denoted A to F, are provided (section 8.3.8.2).

The event-triggered mode has the advantages that, when the radio reception conditions remain good (the specified event does not occur), the Uu and Iub interfaces are not overloaded with “MEASUREMENT REPORT” and/or “DEDICATED MEASUREMENT REPORT” messages, and that the RNC does not waste time executing its radio resource management algorithms on the data contained in these messages. However, if there is a risk of the radio reception conditions deteriorating soon, there is benefit in giving precedence to the periodic mode, preferably with a short interval.

Implementing the invention means giving precedence to the event-triggered report mode over the periodic mode when the variability of the channel is relatively low, that is, when the channel has a relatively high number of multiple paths. In practice, the degradation of another parameter, for example CPICH_RSCP or CPICH_Ec/NO, can often be compensated by the wealth of multiple paths in the channel, which can be evaluated from the variance information returned to the RNC according to the invention.

More generally, a report mode will be adopted giving rise to more frequent or more probable messages when the variability of the channel is high (or when it is increasing) than when it is low (or when it is decreasing). In the periodic mode (which is often the only one implemented), the RNC will have a tendency to shorten the intervals specified in the “MEASUREMENT CONTROL” or “DEDICATED MEASUREMENT INITIATION REQUEST” message when the measured variances are high or increasing, and vice versa. In the event-triggered mode, it is also possible to modify the monitored event and, in particular, the range of values specified in the definition of that event, so that it becomes more probable in the presence of high or increasing variances.

FIGS. 8 and 9 illustrate examples of procedures that can be used by the RNC 12 to specify the report mode that the UE 14 must obey, taking into account the information obtained from the variance measurements.

These figures refer to the RRC protocol. They can immediately be transposed to the control of the nodes B 13 using the NBAP protocol.

In the example of FIG. 8, the terminal is initially in the event-triggered mode, and event lf of the standard has been specified to it (step 60). Consequently, it monitors the received power level measurements of its served cell i, for example the CPICH_RSCPᵢ parameter, comparing it with a threshold S1 (step 61). As long as the level remains greater than this threshold, the UE remains in the event-triggered mode. When the power level falls below the threshold S1, the UE addresses a “MEASUREMENT REPORT” message to its RNC specifying in particular the latest CPICH_RSCPᵢ parameters and the normalized variance Vᵢ (step 62). In analyzing these measurements, the RNC compares the variance Vᵢ with another threshold S2 chosen inversely proportional to the order of the path diversity required in cell i (step 63). If Vᵢ≦S2, the RNC considers itself to be in the presence of a channel with a relatively high number of multiple paths, so it keeps the UE in the event-triggered mode, that is, it does not send it a new “MEASUREMENT CONTROL” message. However, if Vᵢ≦S2 in step 63, the RNC sends the UE a “MEASUREMENT CONTROL” message in step 64, so that the latter switches to the periodic mode in step 65 with a relatively short report interval Tₚ.

Numerous variants can be adopted in the embodiment in FIG. 8. In one of these, the test 63 does not involve comparing the normalized variance Vᵢ with a threshold S2, but rather determining whether this variance received in the last “MEASUREMENT REPORT” message is greater than that received in the preceding message for the same UE and the same cell. The “MEASUREMENT CONTROL” message is then sent in step 64 only if the variance Vᵢ is increasing.

In another variant, when the variance seems relatively low in the test 63 (Vᵢ≦62), the RNC sends a “MEASUREMENT CONTROL” message to switch the UE to the periodic report mode, but with a longer report interval than the interval Tₚ indicated in step 65.

The test of step 63 could also apply cumulatively to the variance Vᵢ and to the signal strength level CPICH_RSCPᵢ, so that the event-triggered mode is maintained only if Vᵢ>S2 and CPICH_RSCPᵢ≧S′1, the threshold S′1 being lower than S1. This still enables the periodic mode to be selected when the degradation of CPICH_RSCPᵢ becomes too severe.

In the example of FIG. 9, the UE 14 is initially in the periodic mode, with a report interval Tₚ (step 70). Consequently, on each period Tₚ, the UE sends the RNC a “MEASUREMENT REPORT” message in which it indicates in particular the latest CPICH_RSCPᵢ and Vᵢ parameters (step 71). In the analysis of these parameters, carried out in step 72, the RNC looks to see if the signal strength level CPICH_RSCPᵢ has become greater than a threshold S3. If it has, it sends a “MEASUREMENT CONTROL” message to the UE to switch it to the event-triggered mode only if the channel between the UE and its served cell has a relatively high number of multiple paths, which is expressed by the condition that the variance Vᵢ is less than a threshold S4. This threshold S4 can in particular be inversely proportional to an order of diversity corresponding to one or two propagation paths. In practice, when the channel generates little diversity, it can be risky to switch to the event-triggered mode, even if the level received on the CPICH seems excellent, because there would be a risk of this resulting in a loss of communication if an obstacle were to cause the dominant propagation path to be lost suddenly. The “MEASUREMENT CONTROL” message sent to the UE in step 73 when CPICH_RSCPᵢ>S3 and Vᵢ<S4 switches the UE to the event-triggered mode in step 74, the event 1f being, for example, monitored thereafter.

As a variant, this “MEASUREMENT CONTROL” message of step 73 could keep the UE in the periodic report mode, but with a longer interval than the interval Tₚ specified in step 70.

As previously, the example of FIG. 9 can comprise multiple variants. In particular, the variance test performed in step 72 can be applied to the variation of the variance rather than to its absolute value, an increasing variance causing the periodic mode to be maintained with the interval Tₚ.

Moreover, procedures such as those of FIGS. 8 and 9 can be based in whole or in part on measurements performed in one communication direction to decide on the measurement report mode to be adopted for the other communication direction. For example, it is possible to envisage maintaining a constant periodic mode for the uplink measurements (“DEDICATED MEASUREMENT REPORT” messages of the NBAP protocol transmitted periodically by the serving node B or the nodes B of the active set) and analyzing the power level measurements received from a UE and the corresponding variance measurements contained in these messages to decide whether this UE must transmit “MEASUREMENT REPORT” messages of the RRC protocol periodically or when triggered by an event, or to choose the reporting interval or the event to be monitored.

In the case where the UE is in communication with certain nodes B, according to a given communication service (speech call, data transmission, etc.), the determination of the report mode can also take into account the service concerned. As an example, if a speech call is in progress between the UE and at least one node B, precedence can be given to switching to or maintaining the periodic transmission mode, on a more sensitive basis than in the case of a data transmission. The speech call is in practice more sensitive to degradations of the radio conditions and therefore requires more frequent observation of these conditions.

To this end, more severe thresholds can be chosen for the various estimated parameters when the service does not stand up well to radio degradations. In the case illustrated in FIG. 8, a lower threshold S2 (and/or a higher threshold S1) can, for example, be chosen for a speech service than for a data service, to favor the switchover from the event-triggered mode to the periodic mode when the radio conditions become degraded. Similarly, lower speed and time variability thresholds S6 and S7 can be used for a speech service than for a data service. Precedence is then given to the switchover from the event-triggered mode to the periodic mode, assuming earlier that the speed of the UE is high and/or that the time variability is high.

In another embodiment of the invention, control of the report mode by the RNC, taking into account the information on the variability of the channels, consists in adding or deleting parameters for which measurement reports must be sent from the UE or from the node B. This can for example be used to adopt differentiated criteria to add or delete cells in the active set, which are based on different parameter measurements depending on whether the observed variability is high or low.

1. A method of controlling radio resources assigned to a communication between a mobile terminal and a cellular network infrastructure, the infrastructure comprising at least one radio network controller and fixed transceivers serving respective cells, the method comprising the steps of:
measuring parameters of respective propagation channels between the mobile terminal and a number of fixed transceivers;
transmitting to the radio network controller report messages indicating at least some of the measured parameters; and
processing the report messages on the radio network controller,
wherein the measured parameters indicated in the report messages for at least one fixed transceiver include data representing a time variability of a power level received on the channel between the mobile terminal and said fixed transceiver.

2. The method as claimed in claim 1, wherein the variability data of a power level include an estimated variance of a time distribution of said power level.

3. The method as claimed in claim 2, wherein said variability data further comprise at least one estimation of a moment of order greater than 2 of said time distribution of the power level.

4. The method as claimed in claim 1, wherein the measured parameters indicated in the report messages for at least one fixed transceiver further comprise an average value of a power level received on the channel between the mobile terminal and said fixed transceiver.

5. The method as claimed in claim 1, wherein the measured parameters indicated in the report messages for at least one fixed transceiver further comprise a signal loss value on the channel between the mobile terminal and said fixed transceiver.

6. The method as claimed in claim 1, wherein the variability data of the power level are measured over a first period and averaged over a second period, longer than the first period, to be included in a report message transmitted to the radio network controller.

7. The method as claimed in claim 1, wherein at least some of the propagation channel parameter measurements are downlink measurements performed by the mobile terminal on pilot signals respectively sent by the fixed transceivers and formed with defined spreading codes.

8. The method as claimed in claim 7, wherein said downlink measurements are transmitted by the mobile terminal to the radio network controller in report messages of a radio resource control protocol, relayed transparently by the fixed transceivers.

9. The method as claimed in claim 1, wherein at least some of the propagation channel parameter measurements are uplink measurements performed by the fixed transceivers on a pilot signal included in signals sent by the mobile terminal on a dedicated channel.

10. The method as claimed in claim 9, wherein said uplink measurements are transmitted by the fixed transceivers to the radio network controller in report messages of an application protocol for controlling the fixed transceivers.

11. The method as claimed in claim 1, wherein the processing of the report messages indicating the data representing the time variability to the radio network controller includes determining an active set of fixed transceivers with respect to the mobile terminal and activating a radio link between the mobile terminal and each fixed transceiver of the active set.

12. The method as claimed in claim 11, wherein the active set is defined according to parameters including the variability data indicated in report messages for a number of fixed transceivers and signal loss values on the respective channels between the mobile terminal and said fixed transceivers.

13. The method as claimed in claim 1, wherein the radio network controller determines an active set of fixed transceivers with respect to the mobile terminal and activates a respective radio link between the mobile terminal and each fixed transceiver of the active set, and wherein the processing of the report messages indicating the data representing the time variability to the radio network controller includes determining a transmit power setting control for each fixed transceiver of the active set with respect to the mobile terminal.

14. The method as claimed in claim 13, wherein the determination of the power setting control is controlled according to parameters including the variability data indicated in report messages for a number of fixed transceivers and signal loss values on the respective channels between the mobile terminal and said fixed transceivers.

15. The method as claimed in claim 1, wherein the processing of the report messages indicating the data representing the time variability to the radio network controller includes determining an initial set point for a closed loop locking the transmit power of the mobile terminal, executed between a fixed transceiver and the mobile terminal, said initial set point being transmitted by the radio network controller to said fixed transceiver.

16. The method as claimed in claim 1, wherein the processing of the report messages indicating the data representing the time variability to the radio network controller includes determining a mode of transmitting to the radio network controller report messages indicating at least some of the measured parameters.

17. The method as claimed in claim 16, wherein the determination of the report message transmission mode includes selecting between a periodic transmission of the report messages and an event-triggered transmission of the report messages.

18. The method as claimed in claim 17, wherein precedence is given to the periodic transmission of the report messages over the event-triggered report message transmission when the time variability of the power level received on the channel between the mobile terminal and a fixed transceiver with which the mobile terminal has an active radio link is greater than a threshold.

19. The method as claimed in claim 17, wherein precedence is given to the periodic transmission of the report messages over the event-triggered report message transmission when the time variability of the power level received on the channel between the mobile terminal and a fixed transceiver with which the mobile terminal has an active radio link is increasing.

20. The method as claimed in claim 16, wherein the determination of the report message transmission mode includes, in the case of periodic report message transmission, selecting the transmission interval of said messages.

21. The method as claimed in claim 20, wherein the selected transmission interval is a decreasing function of the time variability of the power level received on the channel between the mobile terminal and a fixed transceiver with which the mobile terminal has an active radio link.

22. The method as claimed in claim 16, wherein the determination of the report message transmission mode includes, in the case of an event-triggered report message transmission, selecting the event for which the detection gives rise to the transmission of one of said messages.

23. The method as claimed in claim 22, wherein the selected event has a probability of occurrence which is a decreasing function of the time variability of the power level received on the channel between the mobile terminal and a fixed transceiver with which the mobile terminal has an active radio link.

24. The method as claimed in claim 16, wherein the determination of the report message transmission mode also takes into account a service which involves a communication between the mobile terminal and at least one of said fixed transceivers.

25. A radio network controller for a spread spectrum cellular network infrastructure, comprising means of communication with fixed transceivers serving respective cells and with at least one mobile terminal, and means of controlling radio resources assigned to a communication between the mobile terminal and the cellular network infrastructure, wherein the radio resource control means comprise means for requesting, through the communication means, parameter measurement report messages for respective propagation channels between the mobile terminal and a number of fixed transceivers, and means of processing the report messages, and wherein the parameters indicated in the report messages for at least one fixed transceiver include data representing a time variability of a power level received on the channel between the mobile terminal and said fixed transceiver, taken into account by processing means.

26. The radio network controller as claimed in claim 25, wherein the variability data of a power level include an estimated variance of a time distribution of said power level.

27. The radio network controller as claimed in claim 25, including means for determining, from a report message received for a fixed transceiver, a signal loss value on the channel between the mobile terminal and said fixed transceiver.

28. The radio network controller as claimed in claim 25, wherein at least some of the propagation channel parameter measurements are downlink measurements performed by the mobile terminal on pilot signals respectively sent by the fixed transceivers and formed with defined spreading codes.

29. The radio network controller as claimed in claim 28, wherein the communication means include means for recovering said downlink measurements in report messages of a radio resource control protocol, relayed transparently by the fixed transceivers.

30. The radio network controller as claimed in claim 25, wherein said report message processing means include means for determining an active set of fixed transceivers with respect to the mobile terminal and means for activating a respective radio link between the mobile terminal and each fixed transceiver of the active set.

31. The radio network controller as claimed in claim 30, wherein the means for determining the active set operate according to parameters including the variability data indicated in report messages for a number of fixed transceivers and signal loss values on the respective channels between the mobile terminal and said fixed transceivers.

32. The radio network controller as claimed in claim 25, including means for determining an active set of fixed transceivers with respect to the mobile terminal and means for activating a respective radio link between the mobile terminal and each fixed transceiver of the active set, and wherein said processing means include means of controlling the setting of the transmit power for each fixed transceiver of the active set with respect to the mobile terminal.

33. The radio network controller as claimed in claim 32, wherein the transmit power setting control means operate according to parameters including the variability data indicated in report messages for a number of fixed transceivers and signal loss values on the respective channels between the mobile terminal and said fixed transceivers.

34. The radio network controller as claimed in claim 25, wherein said processing means include means of determining an initial set point for a closed loop locking the transmit power of the mobile terminal, executed between a fixed transceiver and the mobile terminal.

35. The radio network controller as claimed in claim 25, wherein said means of processing the report messages indicating the data representing the time variability include means of determining a mode of transmission to the radio network controller of report messages indicating at least some of the measured parameters.

36. The radio network controller as claimed in claim 35, wherein the means of determining the transmission mode are organized to give precedence to an event-triggered transmission mode when said data shows a time variability that is decreasing and/or less than a threshold for the power level received on the channel between the mobile terminal and a fixed transceiver with which the mobile terminal has an active radio link.

37. The radio network controller as claimed in claim 35, wherein the means of determining the transmission mode are organized to give precedence to a periodic transmission mode when said data shows a time variability that is decreasing and/or greater than a threshold for the power level received on the channel between the mobile terminal and a fixed transceiver with which the mobile terminal has an active radio link.

38. A spread spectrum mobile radiocommunication terminal, comprising:
a radio interface for communicating with a cellular network infrastructure comprising at least one radio network controller and fixed transceivers serving respective cells;
means of measuring parameters of respective propagation channels from a number of fixed transceivers; and
means of transmitting to the radio network controller report messages indicating at least some of the measured parameters, including, for at least one fixed transceiver, data representing a time variability of a power level received over the channel between the mobile terminal and said fixed transceiver.

39. The mobile terminal as claimed in claim 38, further comprising:
means of receiving over the radio interface, from the radio network controller, data designating an active set of fixed transceivers; and
a diversity receiver having a number of reception fingers for processing signals respectively received over a number of propagation paths each belonging to a defined propagation profile for a fixed transceiver of the active set, and means of combining the signals processed by the reception fingers to determine common information conveyed by said signals.

40. The mobile terminal as claimed in claim 38, wherein the variability data of a power level include an estimated variance of a time distribution of said power level.

41. The mobile terminal as claimed in claim 38, wherein the measurement means are organized to measure the variability data of the power level over a first period and to average it over a second period, longer than the first period, for transmission to the radio network controller in a report message.

42. The mobile terminal as claimed in claim 38, wherein the measurement means are organized to estimate the variability data over a period adjustable by a configuration command originating from the radio network controller.

43. The mobile terminal as claimed in claim 38, wherein the report messages come under a radio resource control protocol having an instance in the mobile terminal and an instance in the radio network controller, and transparent for the fixed transceivers.

44. A base station for a spread spectrum cellular network infrastructure, comprising at least one radio transceiver serving a respective cell, and means of communication with at least one radio network controller of the cellular network infrastructure, wherein each radio transceiver includes means of measuring parameters of a propagation channel from a mobile terminal in communication with the cellular network infrastructure, and wherein the means of communication with the radio network controller include means of transmitting report messages indicating at least some of the measured parameters, including data representing a time variability of a power level received on said propagation channel from the mobile terminal.

45. The base station as claimed in claim 44, wherein the means of communication with the radio network controller include means of receiving an activation command for a radio link with said mobile terminal, transmitted by the radio network controller after processing the report messages.

46. The base station as claimed in claim 44, wherein the means of communication with the radio network controller include means of receiving a control for setting the transmit power of at least one radio transceiver, transmitted by the radio network controller after processing the report messages.
